(19) United States
(12) Patent Application Publication
(10) Pub. No.: US 2026/0346611 A1
(43) Pub. Date: Nov. 5, 2026

(54) SYSTEM HAVING A DIGITAL PRINTER, AND METHOD FOR PRINTING A PAPER WEB

(71) Applicant: BHS Corrugated Maschinen- und Anlagenbau GmbH, Weiherhammer (DE)

(72) Inventors: Jarne Besser, Weiden i. d. Opf. (DE); Maximilian Mark, Tirschenreuth (DE); Tim Slawik, Bayreuth (DE)

(21) Appl. No.: 19/487,788

(22) PCT Filed: Jun. 4, 2024
(86) PCT No.: PCT/EP2024/065373

§ 371 Date: Nov. 25, 2025

(30) Foreign Application Priority Data
Jun. 6, 2023 (DE) 102023205295.4

(51) Int. Cl. B41J 2/21; B41J 11/00; B41J 15/16; B41J 25/00

(52) U.S. Cl. CPC B41J 2/2103; B41J 2/2114; B41J 2/2146; B41J 11/0015; B41J 11/002; B41J 15/165; B41J 2025/008; B41J 2202/21

(57) ABSTRACT

The invention specifies a system (2) which comprises a digital printer (6), with a plurality of print heads (8, 10, 12), in each case for printing a paper web (4), wherein a first of the print heads (8, 10, 12) is an ink print head (10), for printing the paper web (4) with a colored ink, wherein a varnish printing function is integrated into the digital printer (6), by a second of the print heads (8, 10, 12) being a varnish print head (12), for printing the paper web (4) with a varnish, wherein the varnish print head (12) is arranged downstream of the ink print head (10) along the paper web (4), for overprinting the colored ink with the varnish. The invention also specifies a method for printing a paper web (4).

The invention relates to a system which comprises a digital printer, and to a method for printing a paper web, in particular for corrugated board.

A digital printer is also called an inkjet printer. Printing a paper web with a digital printer is contactless, i.e. a print head of the digital printer does not touch the paper web during printing. Instead, the ink printed by the print head is flung toward the paper web. Accordingly, a digital printer does not require a physical printing plate, resulting in a high degree of freedom in the design of the printed image. Furthermore, even small orders can be carried out economically; no conversion of the system is necessary.

Reference is made to US 2014 029 2843A1, US 2015 0 029 259 A1, US 2005 0 140 763 A1, U.S. Pat. No. 9,004,642B2, EP 1 362 704 A1, EP 2 982 510 B1, EP 1 555 133B1, U.S. Pat. No. 6,655,797B2, US 2006 0 158 481 A1, and US 2020 148 906 A1.

Specifically, US 2005 0 140 763 A1 describes a method for inkjet printing in which a first dye ink and a first fixer ink are applied successively to essentially the same area of a substrate so that the first fixer ink is applied over the first dye ink within a time interval of less than about 125 ms.

Against this background, it is an object of the invention to improve the printing of a paper web in a system having a digital printer. In particular, the system should be as compact as possible. Accordingly, an improved system and an improved method are to be specified.

The object is achieved according to the invention by a system having the features according to claim 1 and by a method having the features according to claim 15. Advantageous embodiments, developments, and variants are the subject-matter of the dependent claims. The statements in connection with the system also apply analogously to the method, and vice versa. If steps of the method are described below implicitly or explicitly, advantageous embodiments of the system result from the system being designed to carry out one or more of these steps.

The system comprises a digital printer, which is also called an inkjet printer. The digital printer comprises a plurality of print heads, in each case for printing a paper web. The paper web is generally conveyed through the system and the digital printer in one conveying direction (also called web running direction) and at one web speed. The print heads are in particular arranged one after the other in the conveying direction, and not next to one another. The paper web is in particular provided as a so-called continuous web, i.e. there is no printing of only individual pages or sheets. For example, the paper web is converted into individual pages or sheets outside the system and in any case only after printing. Accordingly, the system is preferably used to produce a so-called preprint, wherein the term “preprint” here is understood to mean that the printing is carried out before the paper web is processed further, in particular before the paper web is used as a covering web or laminating web of a corrugated board web. Printing the finished corrugated board or corrugated board web, on the other hand, is called post-printing.

For printing, the print heads are lowered toward the paper web as needed and then eject ink in that direction, depending on the corresponding image data, in order to create a print on the paper web. This is done without contact, i.e. the print heads do not touch the paper web during printing or at any other time. A single print head is also called a print row or print bar. Preferably, the digital printer is a so-called single-pass system. Preferably, the print heads are mounted in pairs on so-called carriages, i.e. the digital printer comprises one or more carriages, on each of which exactly two print heads are mounted. Alternatively, more than two print heads are mounted on one carriage. If a plurality of print heads is mounted together on a carriage, the print heads will in particular be arranged one after the other in the conveying direction, and not next to one another. If necessary, each print head is composed of multiple subunits in the transverse direction. Accordingly, the digital printer comprises, in particular, but not necessarily, an even number of print heads. The carriages in particular serve for mechanically holding the print heads and for moving the print heads relative to the paper web (in particular laterally, e.g. for maintenance and/or lowering and raising). Accordingly, the print heads are mechanically coupled to one another in pairs by the carriages; for servicing a single print head, the entire carriage with both print heads must be removed and is moved, for example, laterally to the conveying direction for this purpose. However, for printing, it is preferably possible to control the print heads individually so that they are then independent of one another, at least with regard to the printing.

The first of the print heads is an ink print head, for printing the paper web with a colored ink. In other words, the digital printer comprises a first print head, which is configured for printing color. The colored ink is in particular a water-based ink which contains corresponding color pigments. Examples of colors and colored inks are cyan (C), magenta (M), yellow (Y), and black (K), but other colors are also possible. Preferably, the digital printer even comprises a plurality of print heads, each of which is designed as an ink print head, in particular for printing the paper web with multiple different colored inks of a color system. In a suitable embodiment, the digital printer comprises at least four ink print heads, for printing the paper web with a corresponding number of different colored inks, in particular colored inks of a CMYK color system.

According to the invention, a varnish printing function is additionally integrated into the digital printer by a second of the print heads being a varnish print head, for printing the paper web with a varnish. In other words, the digital printer comprises a second print head, which is configured for printing varnish. The varnish is also called digital varnish since it is now printed by means of a digital printer. Just like the colored ink, the varnish can also be printed selectively, i.e. it is not necessarily printed over the entire surface. The varnish is in particular transparent. The varnish is expediently used to realize an additional function, in particular as mechanical and/or thermal protection of the ink underneath the varnish and/or of the paper web itself. The varnish expediently creates a gloss of at most 55 GU (gloss unit, in particular according to DIN EN ISO 2813, wherein the measurement is taken at an angle of 60°).

The first and second print heads are preferably of the same design and differ primarily in the printed material, namely, the colored ink in one case and the varnish in the other. The print heads are formed separately from one another, i.e. printing with ink and varnish is not carried out with the same print head but with different print heads. The digital printer therefore comprises at least two print heads.

The varnish print head is arranged along the paper web downstream of the ink print head, for overprinting the colored ink with varnish. During the printing of the paper web, the colored ink is accordingly printed first and only then the varnish. In particular, the varnish is printed at least partially on the same area of the paper web as the colored ink so that the colored ink is overprinted by the varnish. In this process, the varnish is in particular printed directly onto the colored ink, i.e. no other material is present or printed between the colored ink and the varnish.

The method according to the invention serves to print a paper web by means of a system which comprises a digital printer with a plurality of print heads, in each case for printing the paper web. Analogously to what has already been said above, at least one of the print heads is an ink print head, by means of which the paper web is printed with a colored ink, and a varnish printing function is integrated into the digital printer, as also already described, by at least one of the print heads being a varnish print head, by means of which the paper web is printed with a varnish. In this process, the varnish print head is arranged along the paper web downstream of the ink print head, and the colored ink is overprinted with the varnish.

When printing with a digital printer, i.e. during digital printing, multiple colored inks are typically applied in order to create a printed image. Colored inks include, for example, the already mentioned cyan, magenta, yellow, and black, alternatively or additionally also special colors such as orange, green, violet, or white. White in particular is expediently printed as a base coat and undercoat for the subsequent, different colored inks.

The printed image with the printed colored inks is suitably dried after printing; for this purpose, the system comprises one or more active dryers, through which the paper web passes. Examples of active dryers include IR emitters and hot air dryers.

After the printed image has dried, it is generally advantageous to print an additional layer of varnish as protection for the printed image. In principle, it is possible to print the paper web with two separate printing units, namely, on the one hand a digital printer (ink printer) for the colored inks and on the other hand a further printer (varnish printer) for the varnish. This further printer can also be a digital printer or alternatively an analog printer, with which an analog varnish application is carried out via a transfer roller, for example. A dryer is then arranged between the ink printer and the varnish printer in order to dry the printed image before overprinting with varnish. After printing with varnish, further drying is carried out by means of a further dryer downstream of the varnish printer. The disadvantage is that the resulting system is very long due to the two printers and the two dryers. The path that the paper web has to travel between the two printers also makes it more difficult to precisely overprint (register) the colored ink and varnish. Furthermore, the system is very energy-and cost-intensive due to the two dryers. Also problematic is the shrinkage that the paper web experiences on its way between the two printers, in particular due to the dryer arranged there. This shrinkage must be corrected in a complex manner, e.g. by means of additionally printed marks and their evaluation and, if necessary, real-time adjustment of the digital print data. Furthermore, drying, in particular multiple times, and typically additionally cooling and re-moistening the paper web are also very complex and energy-intensive and can negatively affect the properties of the paper web. Any defects, which may occur in the paper web on the way between the ink printer and the varnish printer, are also problematic. In some cases, it may be necessary to raise the print heads in the varnish printer so that the varnish application is temporarily discontinued and unvarnished areas result on the paper web. Or the varnish application continues, with the risk of possible damage to the varnish printer.

A key concept of the present invention is a design of the system that is as compact as possible and preferably also energy-saving. A particularly compact design is achieved by integrating, as described above, the varnish application into the digital printer for printing with colored ink, i.e. by combining the varnish application with an ink application in a single digital printer. Accordingly, the system described here only comprises a single digital printer, which is used to print not only colored ink but also varnish. This eliminates the need for an additional varnish printer; the digital printer serves as both an ink printer and a varnish printer. Accordingly, the overall length of the system is significantly reduced. The system described here advantageously has a total length of at most 35 m. In contrast, the total length of a system with two printers would typically be about 50 m. In all of this, it is in particular accepted that the arrangement of a dryer between the ink application and the varnish application is no longer possible or is at least only possible to a greatly reduced extent, i.e. in particular that the paper web between two print heads is heated by a dryer by at most 10 °C, or the dryer has a correspondingly low surface power, or only a correspondingly little water is removed from the paper web.

Preferably, the ink print head and the varnish print head are adjacent to each other and spaced apart by at most 1 m as measured along the paper web. This results in a particularly compact design. The term “adjacent” is in particular understood to mean that the ink print head and the varnish print head follow one another without any further print head being arranged between them. Expediently, the first and second print heads, and in particular all print heads of the digital printer, are housed together in a single housing of the digital printer so that a particularly high level of integration is achieved. A distance between two adjacent print heads as measured along the paper web can also be less than the specified distance of 1 m. Preferably, the distance between the first and the last print head, or from the first of a plurality of ink print heads to the varnish print head, is at most 10 m.

Alternatively or additionally, the first and second print heads, and in particular all print heads of the digital printer, are advantageously arranged in such a way that the paper web is conveyed past the print heads within a dwell time in the range of 0.2 s to 2 s. In other words, a given point on the paper web passes all print heads within 0.2 s to 2 s. This also results in a particularly compact design. The specified range for the dwell time results in particular from a web speed of the paper web through the system in the range of 100 m/min to 1000 m/min. The dwell time between two adjacent print heads can be significantly less than the specified 0.2 s. Preferably, however, the dwell time between the first of a plurality of ink print heads and the varnish print head is at least 150 ms.

Another advantage is that, due to the now very short distance between the ink application and the varnish application, the register is maintained particularly well, i.e. overprinting of colored ink and varnish is carried out with particularly high accuracy. Any shrinkage or swelling between the ink application and the varnish application does not need to be taken into account; it would be negligible at most.

Advantageously, the system is also designed in such a way that no active drying of the paper web, and thus of the printed image, is carried out between the ink print head and the varnish print head of the digital printer. A suitable dryer, e.g. an IR emitter or hot air dryer, is dispensed with. Even passive drying takes place in particular at most insofar as the printed image dries on its way between the first and the second print head. However, due to the short distance, this effect is so minimal that the resulting passive drying is negligible. Accordingly, the colored ink is then expediently overprinted with the varnish while the colored ink is still wet. This is in particular understood to mean that the colored ink introduces a certain amount of water into the paper web and that this water content is still retained to at least 95%, preferably at least 98%, at printing with the varnish. This is also called “wet-on-wet printing.”

Especially with regard to wet-on-wet printing, the colored ink and the varnish are suitably matched to one another with regard to their surface tension. Expediently, the varnish has a lower surface tension than the colored ink. The varnish thus makes possible a greater spreading and better crosslinking and/or connection of the created printed dots. Due to the lower surface tension of the varnish, a smaller contact angle to the substrate is formed. The lower the surface tension, the larger the area covered by a drop of varnish under otherwise identical conditions (larger dot diameter of the individual drop). The decrease in the contact angle is also faster, i.e. the rate at which the drop enlarges is higher. In an advantageous embodiment, the varnish has a surface tension of at most 25 mN/m, preferably in the range of 20 mN/m to 22 mN/m, and/or the colored ink has a surface tension of more than 25 mN/m.

However, the compact design and especially the short dwell time and/or the small distance between the ink print head and the varnish print head is problematic insofar as sufficient drying of the colored ink before the varnish application is no longer possible. The wet varnish mixes with the wet, not yet immobilized colored ink, which can negatively affect the quality of the printed image. However, this disadvantage is accepted in the present case and is advantageously at least reduced by one or more measures as described below.

According to a first suitable measure, the paper web is selected in such a way that the colored ink is absorbed as quickly as possible. A suitable paper web for this purpose is made from uncoated paper.

A second suitable measure is to fix the colored ink to the paper web, e.g. by means of a chemical reaction, preferably by pretreating the paper web with a primer (also called a priming coat). Accordingly, a primer printing function is expediently integrated into the digital printer, analogously to the varnish printing function, by at least one of the print heads (i.e. in particular a third print head) being a primer print head, for printing the paper web with a primer. This is also called digital primer printing. Preferably, the above and the following statements regarding the relationship (distance, dwell time, spatial arrangement, etc.) of the ink print head relative to the varnish print head apply analogously to the primer print head relative to the ink print head. In particular, the primer is then printed upstream of the colored ink and overprinted with the colored ink while the primer is still wet. In this respect, the statements regarding wet-on-wet printing of colored ink and varnish apply analogously so that overall a wet-on-wet-on-wet printing of primer, colored ink and varnish is realized overall.

Alternatively or additionally, the system comprises a primer application unit, for applying a primer to the paper web, wherein the primer application unit is arranged upstream of the digital printer. This is also called analog primer printing.

Fixing by means of a primer as described is particularly expedient for a paper web made from coated paper. Coated papers are papers that have a coating in particular of a thickness in the range of 1 μm to 30 μm. This coating in particular contains one or more inorganic materials, such as CaCO₃, kaolin, TiO₂, Al₂O₃, or other inorganic materials that contribute to an improvement in the whiteness, paper smoothness, printability or one or more other functional properties of the paper web. Optionally, the coating contains a binder for increasing strength and/or other process additives. The primer application can be carried out digitally or analogously.

In the case of a paper web made of coated paper, intermediate drying of the primer by means of a suitable dryer is expediently carried out between the primer application and the ink application. In the case of a paper web made of uncoated paper, such intermediate drying is merely optional. With a digital primer application, intermediate drying can be dispensed with.

The primer generally represents a pre-coating. As an alternative or in addition to the primer, printing with a white ink is also advantageous as a pre-coating. The foregoing statements regarding the primer also apply analogously to printing the paper web with a white ink before printing with one or more other colored inks. Any pre-coating, whether primer or white ink, expediently increases the C-value (chroma) and/or the L-value (lightness) of the subsequently printed colors by at least 10% in comparison to a print on the paper web without such a pre-coating.

According to a third suitable measure, the paper web is made of a special paper which intrinsically causes the colored ink to be fixed to the paper web.

In the region of the print heads, the paper web is preferably guided along an arcuate path, e.g. by means of multiple conveyor rollers, rods, and/or guide rollers, which are arranged along an imaginary arc and which each create a spatial change in the direction of the guidance of the paper web. The corresponding multiple changes in direction then result in the aforementioned arc. The paper web is then supported by the conveyor rollers, rods, and/or guide rollers and runs between them in particular in a straight line and overall in an arc shape. In this process, all conveyor rollers in particular only touch one side of the paper web, namely, the unprinted side of the paper web. Accordingly, printing by the print heads is carried out on the other, opposite side.

An arcuate guidance of the paper web is also possible by means of a printing cylinder, also called a central cylinder. In this case, the paper web actually follows a continuous arcuate path. In an advantageous embodiment, the digital printer comprises a printing cylinder, for guiding the paper web, and the print heads are arranged around the printing cylinder, for printing the paper web on the printing cylinder. The paper web is wrapped around the printing cylinder, in particular around at least a quarter or half of the circumference of the printing cylinder and is then both supported and guided by the printing cylinder. The print heads are thus arranged along an imaginary arc around the printing cylinder, wherein this imaginary arc is expediently part of an imaginary circle which is concentric with the printing cylinder. The print heads span an angle (also called angle range) which is suitably in the range of 90° to 180°, preferably 120° to 180°, depending on the number of print heads and their distance from one another. Preferably, the digital printer comprises 6 to 18 print heads. The print heads or at least the carriages are suitably arranged equidistantly (i.e. at the same distance or at the same angle) from one another. The printing cylinder expediently has a diameter in the range of 1.6 m to 2 m.

The arcuate guidance advantageously prevents the paper web from curling at its edges, reduces or prevents creases in the middle of the paper web and generally ensures particularly stable running of the paper web. In the case of a central cylinder, the contact and friction between the paper web and the central cylinder also advantageously reduces swelling of the paper web when moisture is introduced by printing.

Irrespective of whether a printing cylinder is used, it is advantageous if the print heads are arranged together along an imaginary arc. The imaginary arc is not necessarily a circular arc.

In a preferred embodiment, the ink print head and the varnish print head are arranged at an angle of at least 10° relative to each other, in particular if these two print heads are also adjacent to each other, i.e. no further print head is arranged between them. In general, any two adjacent print heads are arranged at an angle of at least 10° relative to each other. For a digital printer with 6 to 18 print heads, this in particular results in the already mentioned angle of 90° to 180° for the print heads as a whole.

Expediently, the system comprises a dryer for drying the paper web, and the system is further designed in such a way that at least one printed side of the paper web is conveyed from the ink print head to the dryer without contact. The printed side is the side on which colored ink and/or varnish is printed with the print heads. Preferably, the printed side of the paper web is conveyed without contact, at least from the ink print head to the varnish print head. An appropriate non-contact conveyance is in particular possible if the paper web is guided with conveyor rollers or a printing cylinder as described above. No machine element touches the printed side of the paper web, in particular not in any unprinted areas of the generally printed side.

An embodiment in which the digital printer comprises at least two varnish print heads that can be controlled independently of one another is also advantageous. This makes it possible to remove one of the varnish print heads from the digital printer during operation, e.g. for maintenance, while the other varnish print head continues to print varnish. A so-called “print-while-clean” operation is thus possible. The same applies analogously to the ink print head and, if applicable, also to the primer print head. Preferably, all print heads are accordingly provided redundantly.

In a suitable embodiment, the digital printer comprises at least two carriages, on each of which two of the print heads are arranged, and the two carriages are mutually redundant with regard to the colored inks and/or varnishes that can be printed with the print heads of the two carriages. For example, this means that, for an ink print head with the colors cyan and magenta, there are two carriages, each with an ink print head for cyan and magenta, so that removal during continued operation is possible here as well.

Some suitable configurations for a digital printer are specified below, wherein each letter represents a print head and indicates its colored ink (C: cyan, M: magenta, Y: yellow, O: orange, G: green, Vio: violet, K: black, W: white and, in general, F: colored ink), varnish (V), or primer (P). The expression (EMPTY) indicates that no print head is used at this location. Two print heads are grouped together in one carriage; the carriages are separated by hyphens (-). The paper web passes the print heads from left to right.
1. PP-FF-FF-FF-FF-W
2. PP-WW-FF-FF-FF-FF-W
3. PW-YC-YC-MK-MK-VV
4. PW-WY-YM-MC-CK-W
5. PW-WY-YM-MC-CK-K(EMPTY)-VV
6. PP-WW-YY-MM-OO-GG-KK-W
7. PP-YY-MM-OO-GG-VioVio-KK-W

In addition, other variants are also suitable. If a primer (P) is used, the corresponding primer print head is arranged upstream of any ink print heads. On the other hand, a varnish print head (V) is arranged in particular downstream of any ink print heads. In order to achieve the redundancy described above, it is advantageous to mount two varnish print heads in different carriages so that one of the varnish print heads is then arranged upstream of a single ink print head if necessary.

Preferably, the system comprises a dryer with an inlet for the paper web, and the inlet of the dryer is arranged at most 5 m downstream of the varnish print head as measured along the paper web. The dryer mentioned is preferably also the only dryer in the entire system (however, there may be a further dryer specifically for the primer if the primer is printed outside the digital printer). The system is particularly compact due to the close arrangement of the dryer relative to the varnish print head and thus relative to the digital printer as a whole. The dryer comprises, in particular, one or more IR emitters or one or more hot air dryers, or a combination thereof. Advantageously, the paper web undergoes a change in direction on its way from the digital printer to the dryer. In a suitable embodiment, the paper web is deflected by at least 5° on its way from the varnish print head to the drying unit. However, the printed side of the paper web preferably remains untouched.

The system suitably comprises a nozzle inspection system, which analyzes the printed image downstream of the varnish print head and, in particular, in general, downstream of the digital printer in order to detect a malfunction of one or more nozzles of the print heads. In this process, the same nozzle inspection unit detects malfunctions of both the ink print head and the varnish print head and, if applicable, of further print heads, i.e. the system comprises only a single nozzle inspection system for all print heads. Preferably, the dried printed image is examined by the nozzle inspection system, i.e. the nozzle inspection system is also suitably arranged downstream of the dryer already described. This yields a more accurate result than an analysis of the still-wet printed image.

In the following, exemplary embodiments of the invention are explained in more detail with reference to drawings. The drawings show schematically:

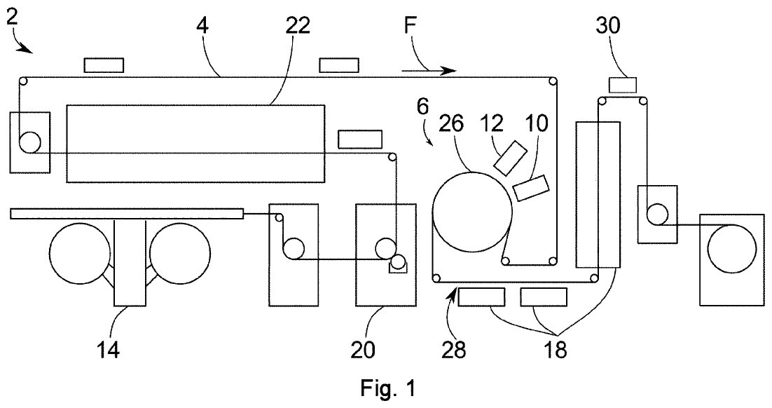

FIG. 1 a system,

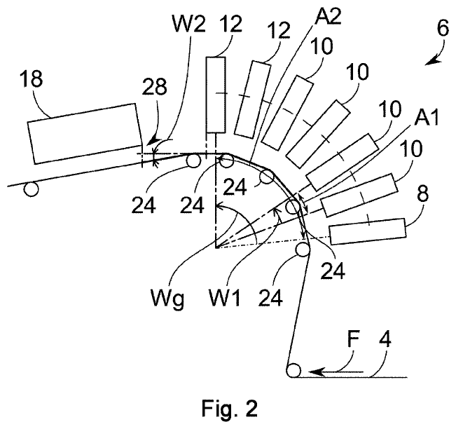

FIG. 2 a digital printer for the system in FIG. 1,

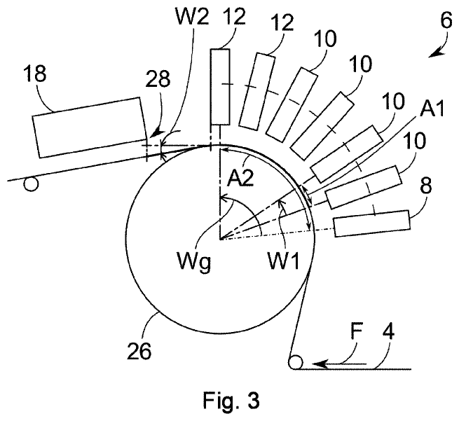

FIG. 3 a variant of the digital printer in FIG. 2,

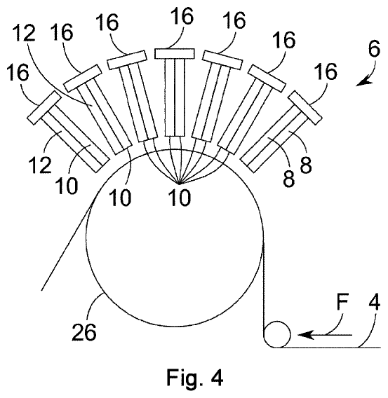

FIG. 4 another variant of the digital printer in FIG. 2.

FIG. 1 is a side view of a system 2 for printing a paper web 4. The system 2 comprises a digital printer 6, two exemplary embodiments of which are likewise shown in a side view in FIGS. 2 to 4. The digital printer 6 comprises a plurality of print heads 8, 10, 12, in each case for printing the paper web 4, which is generally conveyed through the system 2 and the digital printer 6 in a conveying direction F and at a web speed. In the present case, the paper web 4 is provided as a so-called continuous web, i.e. there is no printing of only individual pages or sheets. For this purpose, the system 2 comprises a splicer 14 with two dispensers for paper rolls so that a new paper roll is attached to the end of a paper roll. For example, the paper web 4 is converted into individual pages or sheets outside the system 2 and in any case only after printing. Accordingly, the system 2 is used to produce a so-called preprint, wherein the term “preprint” here is understood to mean that the printing is carried out before the paper web is processed further, in particular before the paper web is used as a covering web or laminating web of a corrugated board web. Printing the finished corrugated board or corrugated board web, on the other hand, is called post-printing.

For printing, the print heads 8, 10, 12 are lowered toward the paper web 4 as needed and then eject ink in that direction, depending on the corresponding image data, in order to create a print on the paper web 4. This is done without contact, i.e. the print heads 8, 10, 12 do not touch the paper web 4 during printing or at any other time. In the present case, the print heads 8, 10, 12 are mounted in pairs on so-called carriages 16, i.e. the digital printer 6 comprises one or more carriages 16, on each of which exactly two print heads 8, 10, 12 are mounted. The carriages 16 serve for mechanically holding the print heads 8, 10, 12 and for moving them. Accordingly, the print heads 8, 10, 12 are mechanically coupled to one another in pairs by the carriages 16.

A first of the print heads 8, 10, 12 is an ink print head 10, for printing the paper web 4 with a colored ink, i.e. a first print head 10 is configured for printing ink. In the exemplary embodiments shown here, the digital printer 6 even comprises a plurality of print heads 10, each of which is designed as an ink print head 10, for printing the paper web 4 with multiple different colored inks of an ink system.

Additionally, a varnish printing function is integrated into the digital printer 6 by a second of the print heads 8, 10, 12 being a varnish print head 12 for printing the paper web 4 with a varnish, i.e. a second print head 12 is configured for printing varnish. The varnish is also called digital varnish since it is now printed by means of a digital printer 6. Just like the colored ink, the varnish can also be printed selectively, i.e. it is not necessarily printed over the entire surface.

The first and second print heads 10, 12 and all other print heads 8, 10, 12 are of the same design and differ primarily in the printed material, namely, the colored ink in one case and the varnish in the other and, in the present case, also an optional primer. The print heads 8, 10, 12 are formed separately from one another.

The varnish print head 12 is arranged downstream of the ink print head 10 along the paper web 4, for overprinting the colored ink with varnish. During the printing of the paper web 4, the colored ink is accordingly printed first and only then the varnish. The varnish is printed at least partially on the same area of the paper web 4 as the colored ink so that the colored ink is overprinted with the varnish. The varnish is printed directly onto the colored ink.

When printing with a digital printer 6, i.e. during digital printing, multiple colored inks are typically applied (and also in the exemplary embodiments shown here) in order to create a printed image. Colored inks include, for example, the already mentioned cyan, magenta, yellow, and black, alternatively or additionally also special colors such as orange, green, violet, or white. White in particular is expediently printed as a preprint and undercoat for the subsequent, different colored inks. If a primer is used, the corresponding primer print head 8 is arranged upstream of any ink print heads 10. On the other hand, a varnish print head 12 is arranged downstream of any ink print heads 10. In order to achieve redundancy, two varnish print heads 12 are, for example, mounted in different carriages 16 so that one of the varnish print heads 12 is then arranged upstream of a single ink print head 10 if necessary.

In the embodiments in FIGS. 2 and 3, the digital printer 6 comprises two varnish print heads 12, four ink print heads 10, and an optional primer print head 8, which can be controlled independently of one another. In the embodiment in FIG. 4, the digital printer 6 comprises two varnish print heads 12, ten ink print heads 10, and two optional primer print heads 8, wherein the print heads 8, 10, 12 are mounted in pairs on seven carriages 16. The two varnish print heads 12 are mounted on different carriages 16 so that one varnish print head 12 is available for maintenance or can be replaced, while varnish continues to be printed using the other varnish print head 12.

The printed image is dried after printing; for this purpose, the system comprises one or more active dryers 18 through which the paper web 4 passes. Examples of active dryers 18 include IR emitters and hot air dryers.

The system 2 shown here has a particularly compact design. This is achieved by integrating the varnish application into the digital printer 6 for printing with colored ink, i.e. varnish application is combined with the ink application in a single digital printer 6. Accordingly, the system 2 described here only comprises a single digital printer 6, which is used to print both colored ink and varnish. The system 2 shown here has a total length of at most 35 m.

In the present case, one of the ink print heads 10, namely, the last ink print head 10, is adjacent to the varnish print head 23 and is spaced apart therefrom by at most 1 m as measured along the paper web 4, i.e. a distance A1 along the paper web is at most 1 m. No further print head is arranged between this ink print head 10 and the varnish print head 12. All print heads 8, 10, 12 are housed together in a single housing of the digital printer 6. A distance A1 between two adjacent print heads as measured along the paper web 4 can also be less than the specified distance A1 of 1 m. A distance A2 between the first and the last print head 8, 10, 12, or from the first of a plurality of ink print heads 10 to the varnish print head 12, is at most 10 m.

Furthermore, in the present case, all print heads 8, 10, 12 of the digital printer 6 are arranged in such a way that the paper web 4 is conveyed past the print heads 8, 10, 12 at a web speed in the range of 100 m/min to 1000 m/min within a dwell time in the range of 0.2 s to 2 s. The dwell time between two adjacent print heads 8, 10, 12 can be significantly less than the specified 0.2 s. The dwell time between the first of a plurality of ink print heads 10 and the varnish print head 12 is at least 150 ms.

The system 2 shown here is also designed in such a way that no active drying of the paper web 4 is carried out between the ink print heads 10 and the varnish print head 12 of the digital printer 6. Even passive drying takes place at most insofar as the printed image dries on its way between the first and the second print head 10, 12. However, this effect is negligible. Accordingly, the colored ink is then overprinted with the varnish while the colored ink is still wet. This is also called “wet-on-wet printing.”

Especially with regard to wet-on-wet printing, the colored ink and the varnish are matched to one another with regard to their surface tension. For example, the varnish has a lower surface tension than the colored ink.

Sufficient drying of the colored ink before applying the varnish is no longer possible. The wet varnish mixes with the wet, not yet immobilized colored ink. However, this is accepted in the present case and is at least reduced by one or more optional measures as described below.

According to a first measure, the paper web 4 is made of uncoated paper so that the colored ink is absorbed as quickly as possible.

A second measure is to fix the colored ink to the paper web 4, e.g. by pretreating the paper web 4 with a primer. Accordingly, a primer printing function is integrated into the digital printer 6, analogously to the varnish printing function, by at least one of the print heads 8, 10, 12 being a primer print head 8 (third print head) for printing the paper web 4 with a primer. The above and following statements regarding the relationship of the ink print head 10 relative to the varnish print head 12 apply analogously to the primer print head 8 relative to the ink print head 10. The primer is printed upstream of the colored ink and overprinted with the colored ink while the primer is still wet. In this respect, the statements regarding wet-on-wet printing of colored ink and varnish apply analogously so that overall a wet-on-wet-on-wet printing of primer, colored ink and varnish is realized overall. Alternatively or additionally, as shown, for example, in FIG. 1, the system 2 comprises a primer application unit 20 for applying a primer to the paper web 4, wherein the primer application unit 20 is arranged upstream of the digital printer 6. Fixing by means of a primer as described is particularly expedient for a paper web 4 made from coated paper.

In the case of a paper web 4 made of coated paper, intermediate drying of the primer by means of a suitable dryer 22 is carried out between the primer application and the ink application. In the case of a paper web 4 made of uncoated paper, such intermediate drying is merely optional. With a digital primer application, intermediate drying can be dispensed with.

According to a third measure, the paper web 4 is made of a special paper which intrinsically causes the colored ink to be fixed to the paper web 4.

As can be seen in FIGS. 2 and 4, the paper web 4 is guided along an arcuate path in the region of the print heads 8, 10, 12. In FIG. 2, multiple conveyor rollers 24 are arranged along an imaginary arc for this purpose. The paper web 4 is then supported by the conveyor rollers 24 and runs between them in a straight line and overall in an arc shape. Here, all conveyor rollers 24 only touch one side of the paper web 4, namely, the unprinted side of the paper web 4. Accordingly, printing by the print heads 8, 10, 12 is carried out on the other, opposite side.

An arcuate guidance of the paper web 4 is also possible by means of a printing cylinder 26, e.g. as shown in FIGS. 3 and 4. Here, the paper web 4 actually follows a continuous arcuate path. The digital printer 6 accordingly comprises a printing cylinder 26, for guiding the paper web 4, and the print heads 8, 10, 12 are arranged around the printing cylinder 26, for printing the paper web 4 on the printing cylinder 26. The paper web 4 is wrapped around the printing cylinder 26, in the present case around at least a quarter or half of the circumference of the printing cylinder 26 and is then both supported and guided by said printing cylinder. The print heads 8, 10, 12 are thus arranged along an imaginary arc around the printing cylinder 26, wherein this imaginary arc is part of an imaginary circle which is concentric with the printing cylinder 26. The print heads 8, 10, 12 span an angle Wg of 90° to 180°, e.g. 120°, depending on the number of print heads 8, 10, 12 and their distance A1 from one another.

The print heads 8, 10, 12 or at least the carriages 16 are arranged equidistantly from one another. In the exemplary embodiments shown here, the print heads 8, 10, 12 are arranged at an angle W1 of at least 10° relative to one another.

The system 2 also comprises a dryer 18 for drying the paper web 4 and is designed in such a way that at least one printed side of the paper web 4 is conveyed from the ink print head 10 to the dryer 18 without contact. The printed side is the side on which colored ink and/or varnish is printed with the print heads 10, 12. The printed side of the paper web 4 is thus also conveyed without contact from the ink print head 10 to the varnish print head 12. No machine element touches the printed side of the paper web 4.

The dryer 18 has an inlet 28 for the paper web 4, and the inlet 28 of the dryer 18 is arranged at most 5 m downstream of the varnish print head 12 as measured along the paper web 4. On its way from the digital printer 6 to the dryer 18, the paper web 4 also undergoes a change in direction W2.

The system 2 also comprises an optional nozzle inspection system 30, which analyzes the printed image downstream of the varnish print head 12 and, in general, downstream of the digital printer 6 in order to detect a malfunction of one or more nozzles of the print heads 8, 10, 12. In this process, the same nozzle inspection unit 30 detects malfunctions of both the ink print head 10 and the varnish print head 12 and, if applicable, further print heads 8, 10, 12, i.e. the system 2 comprises only a single nozzle inspection system 30 for all print heads 8, 10, 12.

### LIST OF REFERENCE SIGNS

2 System
4 Paper web
6 Digital printer
8 Print head (primer, primer print head, third print head)
10 Print head (colored ink, ink print head, first print head)
12 Print head (varnish, varnish print head, second print head)
14 Splicer
16 Carriage
18 Dryer
20 Primer application unit
22 Dryer (for primer)
24 Conveyor roller
26 Printing cylinder
28 Inlet (of the dryer)
30 Nozzle inspection system
A1, A2 Distance
F Conveying direction
W1 Angle
W2 Change in direction
Wg Angle

1. A system comprising a digital printer with a plurality of print heads for printing a paper web,
wherein a first of the print heads is an ink print head, for printing the paper web with a colored ink,
wherein a varnish printing function is integrated into the digital printer by a second of the print heads being a varnish print head for printing the paper web with a varnish,
wherein the varnish print head is arranged downstream of the ink print head along the paper web, for overprinting the colored ink with the varnish.

2. The system according to claim 1,
wherein the ink print head and the varnish print head are adjacent to each other and spaced apart by at most 1 m as measured along the paper web.

3. The system according to claim 1,
wherein the print heads are arranged in such a way that the paper web is conveyed past the print heads within a dwell time in the range of 0.2 s to 2 s.

4. The system according to claim 1,
wherein the varnish has a lower surface tension than the colored ink.

5. The system according to claim 1,
wherein the print heads are arranged together along an imaginary arc.

6. The system according to claim 1,
wherein the digital printer comprises a printing cylinder, for guiding the paper web

(4)
wherein the print heads are arranged around the printing cylinder for printing the paper web on the printing cylinder.

7. The system according to claim 1,
wherein the ink print head and the varnish print head are arranged at an angle (W1) of at least 10° relative to each other.

8. The system according to claim 1,
wherein said system is designed in such a way that no active drying of the paper web is carried out between the ink print head and the varnish print head of the digital printer.

9. The system according to claim 1,
wherein said system comprises a dryer for the paper web and is designed in such a way that at least one printed side of the paper web is conveyed from the ink print head to the dryer without contact.

10. The system according to claim 1,
wherein the digital printer comprises at least two varnish print heads that can be controlled independently of one another.

11. The system according to claim 1,
wherein the digital printer comprises at least two carriages on each of which two of the print heads are arranged,
wherein the two carriages are mutually redundant with regard to the colored inks and/or varnishes which can be printed with the print heads of the two carriages.

12. The system according to claim 1,
wherein a primer printing function is integrated into the digital printer by at least one of the print heads being a primer print head, for printing the paper web with a primer,
wherein the primer print head is arranged upstream of the ink print head.

13. The system according to claim 1,
wherein said system comprises a primer application unit for applying a primer to the paper web,
wherein the primer application unit is arranged upstream of the digital printer.

14. The system according to claim 1,
wherein said system comprises a dryer with an inlet for the paper web,
wherein the inlet of the dryer is arranged at most 5 m downstream of the varnish print head as measured along the paper web.

15. A method for printing a paper web by means of a system which comprises a digital printer with a plurality of print heads for printing the paper web,
wherein at least one of the print heads is an ink print head by means of which the paper web is printed with a colored ink,
wherein a varnish printing function is integrated into the digital printer by at least one of the print heads being a varnish print head by means of which the paper web is printed with a varnish,
wherein the varnish print head is arranged downstream of the ink print head along the paper web and the colored ink is overprinted with the varnish.

16. The method according to claim 15,
wherein the colored ink is overprinted with the varnish while the colored ink is still wet.

17. The method according to claim 16,
wherein a primer is printed upstream of the colored ink, which primer is overprinted with the colored ink while the primer is still wet.
